(19) United States
(12) Patent Application Publication
(10) Pub. No.: US 2008/0288945 A1
(43) Pub. Date: Nov. 20, 2008

(54) METHOD AND SYSTEM FOR ANALYZING INTERRELATED PROGRAMS

(75) Inventors: Kwan L. Tong, Yorba Linda, CA (US); Manfred A. Newhart, Long Beach, CA (US); Cathy A. Schmidt, Laguna Niguel, CA (US); Steve W. Lee, Tustin, CA (US); Ronald Paul Hill, Santa Rosa, CA (US)

Correspondence Address: LAW OFFICE OF DONALD D. MONDUL, 3060 BONSAI DRIVE, PLANO, TX, 75093, US

(73) Assignee: Boeing Company, a corporation of the State of Delaware, Chicago, IL (US)

(21) Appl. No.: 11/767,682

(22) Filed: Jun. 25, 2007

Related U.S. Application Data
(60) Provisional application No. 60/930,390, filed on May 15, 2007.

(51) Int. Cl. G06F 9/46

(52) U.S. Cl. 718/103

(57) ABSTRACT

A method for analyzing a program having a budget, an implementation schedule and a deployment plan includes: (a) in no particular order: (1) providing a digital representation of the budget including first entries; (2) providing a digital representation of the schedule including second entries having a first relation with the first entries; and (3) providing a digital representation of the deployment plan including third entries having at least one second relation with at least one of the first and second entries; (b) establishing an expression embodying the first and second relations; (c) exercising the expression to alter at least one altered entry of the selected first second and third entries; and (d) observing at least one entry of the selected first second and third entries other than the at least one altered entry.

### BACKGROUND

Embodiments of the invention may provide a user friendly method and system for analyzing interaction and interdependency among budget, schedule and performance for a program or a set of programs; and for analyzing deployment or planned deployment of elements of the program or programs. The method and system may be expanded to permit analysis of interdependency of risk and technology readiness levels vis-á-vis parameters of budget, schedule, and deployment performance. Embodiments of the method and system of the invention may be advantageously employed, by way of example and not by way of limitation, in connection with analyzing U.S. Missile Defense Agency programs that lead to the development and operations of a Ballistic Missile Defense System (BMDS).

Embodiments of the invention may permit decision makers to determine the impacts in aspects of a program caused by changing parameters involved in other aspects of the program. By way of example and not by way of limitation, embodiments of the invention may permit decision makers to observe the impact of changing a parameter in budget, schedule or the deployment of assets, relating to a program, as the impact is then manifested in the other two of budget, schedule and deployment of assets. Such analysis may permit the exploration of options for changes that may be made in a program, what-if analysis relating to a program, or the exercise of other analytical tools.

Missile Defense planners may be required to make decisions on how to allocate budgeted funds each year. Budget decisions may affect the schedules for the various missile defense elements and may ultimately affect the availability of defense weapons and the defensive capabilities of the Ballistic Missile Defense System over time. The relationships among the cost, schedule, and performance of each element of a program such as the Ballistic Missile Defense System may be intertwined. Such an intertwined relationship may make it difficult to ascertain the effects of budget decisions. By way of example and not by way of limitation, budget decisions may affect a program element under consideration as well as other elements both in the fiscal year under consideration as well as in future fiscal years. This may impact the Ballistic Missile Defense System deployment and operations over time.

There is a need for a method and system for analyzing a program that may permit a user to evaluate the impact caused by a decision or change made in one area of a program as the impact may be manifested in other areas of the program or other related programs.

### SUMMARY

A method for analyzing a program having a budget, an implementation schedule and a deployment plan may include: (a) in no particular order: (1) providing a digital representation of the budget including first entries; (2) providing a digital representation of the schedule including second entries having a first relation with the first entries; and (3) providing a digital representation of the deployment plan including third entries having at least one second relation with at least one of the first and second entries; (b) establishing an expression embodying the first and second relations; (c) exercising the expression to alter at least one altered entry of the selected first second and third entries; and (d) observing at least one entry of the selected first second and third entries other than the at least one altered entry. This method may apply to multiple and related programs within a Ballistic Missile Defense System because of the interrelationship among programs within the BMDS.

A system for facilitating analysis of a program having a budget, an implementation schedule and a deployment plan for effecting a planned result may include: (a) a computing apparatus; (b) a digital representation of the budget coupled for access by the computing apparatus; the budget including a plurality of first detailed entries; (c) a digital representation of the schedule coupled for access by the computing apparatus; the schedule including a plurality of second detailed entries; selected second detailed entries of the plurality of second detailed entries having at least one first relation with selected first detailed entries of the plurality of first detailed entries; (d) a digital representation of the deployment plan coupled for access by the computing apparatus; the deployment plan including a plurality of third detailed entries; selected third detailed entries of the plurality of third detailed entries having at least one second relation with at least one of the selected first detailed entries and the selected second detailed entries; (e) at least one expression configured for exercising by the computing apparatus; the at least one expression embodying the at least one first relation and the at least one second relation; the exercising at least one expression effecting altering at least one altered detailed entry of the selected first detailed entries, the selected second detailed entries and the selected third detailed entries; observing at least one detailed entry of the selected first detailed entries, the selected second detailed entries and the selected third detailed entries other than the at least one altered detailed entry effecting the facilitating.

It is, therefore, a feature of embodiments of the present invention to provide a method and system for analyzing a program or a set of related programs that may permit a user to evaluate impact caused by a decision or change made in one area of a program as the impact may be manifested in other areas of the program or set of programs.

Further features of embodiments of the invention will be apparent from the following specification and claims when considered in connection with the accompanying drawings, in which like elements are labeled using like reference numerals in the various figures, illustrating exemplary embodiments of the invention.

### BRIEF DESCRIPTION OF THE DRAWINGS

FIG. 1 is a schematic diagram illustrating top level logic employed in embodiments of the invention.

FIG. 2 is a schematic diagram illustrating an expanded expression of portions of logic illustrated in FIG. 1.

FIG. 3 is a schematic diagram illustrating logic relationships associated with operating embodiments of the present invention.

FIG. 4 is a flow chart illustrating an embodiment of the method of the invention.

FIG. 5 is a block diagram illustrating an embodiment of the system of the invention.

### DETAILED DESCRIPTION

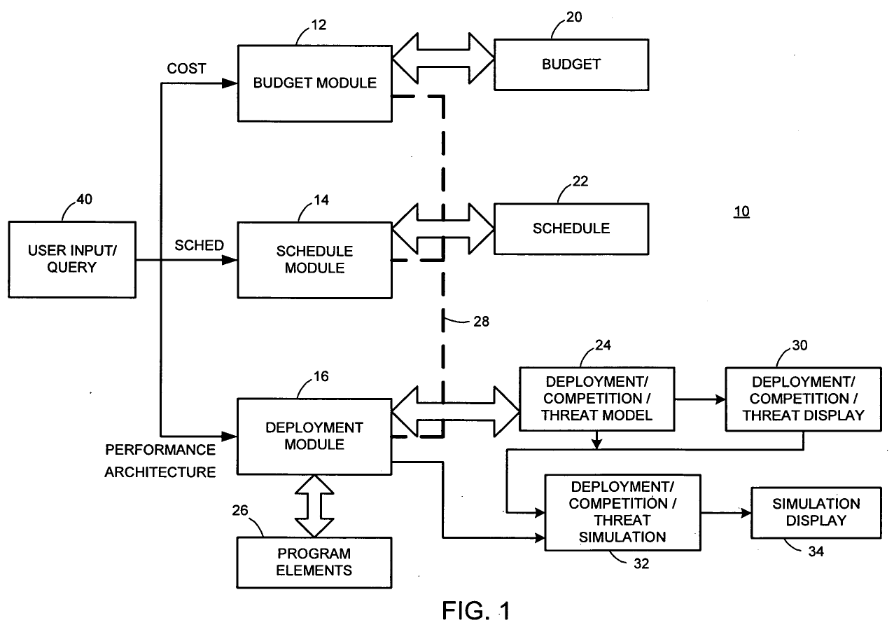

FIG. 1 is a schematic diagram illustrating top level logic employed in embodiments of the invention. In FIG. 1, a system 10 for analyzing a program may include a budget module 12, a schedule module 14 and a deployment module 16. Budget module 12 may be configured to receive and update a digital representation of a budget plan 20. Schedule module 14 may be configured to receive and update a digital representation of a schedule plan 22.

Deployment module 16 may be configured to receive and update a digital representation of a deployment plan 24 of products of the program. Deployment module 16 may also be configured to receive and update a digital representation of program elements 26 associated with the program being analyzed by system 10. Deployment plan 24 may be embodied, by way of example and not by way of limitation, in a model of a threat (e.g., threat of attack, in the case of a ballistic missile defense program) or a model of engagement (e.g., engaging of the threat missiles with the deployed assets, in the case of ballistic missile defense program). By way of further example and not by way of limitation, deployment plan 24 may be embodied in a model of anticipated competition (e.g., sales competition in a new market, as in the case of an expansion of territory for a business). Deployment plan 24 may embody a model of another challenge to be met by a program or set of programs.

Deployment plan 24 may be configured to cooperate in presenting a deployment display 30. Deployment plan 24 may also cooperate with deployment module 16 to exercise a deployment simulation 32. A simulation display 34 may be employed to aid a user in analyzing a simulation. By way of example and not by way of limitation, in the case of a Ballistic Missile Defense Program deployment plan 24 may be embodied in a National Missile Defense Simulation (NMDSIM) module setting out a threat scenario with selected laydown parameters, deployment display 30 may be embodied in an NMDSIM display to show defended areas and time line information relating to aspects of a Ballistic Missile Defense System (BMDS), deployment simulation 34 may be embodied in an ISIS Module for running a 1-on-1 engagement simulation relating to a selected threat and simulation display 34 may be embodied in a GlobeView display to aid a user in visualizing effects of changes made in running a simulation. ISIS is a proprietary simulation tool of the Assignee hereto for use in simulating operations based upon provided data. GlobeView is a proprietary graphic tool of the Assignee hereto for use in displaying data.

The digital representation of budget plan 20 may include a plurality of first detailed entries (not shown in detail in FIG. 1, but well understood by one skilled in the art of digital information system design). By way of example and not by way of limitation, first detailed entries of budget plan 20 may include the funding in each fiscal year to accomplish some task that is part of the program being analyzed. The digital representation of schedule plan 22 may include a plurality of second detailed entries (not shown in detail in FIG. 1, but well understood by one skilled in the art of digital information system design). By way of example and not by way of limitation, second detailed entries of schedule plan 22 may include the start and end date of some task that is part of the program being analyzed. Selected of the second detailed entries may have at least one first relation with selected of the first detailed entries. The digital representation of deployment plan 24 may include a plurality of third detailed entries (not shown in detail in FIG. 1, but well understood by one skilled in the art of digital information system design). By way of example and not by way of limitation, third detailed entries of deployment plan 24 may include a definition of the products being produced by the program being analyzed. Selected of the third detailed entries may have at least one second relation with at least one of the selected first detailed entries and the selected second detailed entries. The relations among detailed entries of budget plan 20, schedule plan 22 and deployment plan 24 are represented by a dashed line 28 coupling budget model 12, schedule model 14 and deployment module 16.

System 10 may also include a user input unit 40 coupled with budget module 12 for altering budget items, such as cost. User input unit 40 may also be coupled with schedule module 14 for altering schedule items, such as schedule timing. User input unit 40 may also be coupled with deployment module 16 for altering deployment items, such as performance requirements or architecture of a deployment of program elements produced according to the program being analyzed.

By way of example and not by way of limitation, the program analyzed by system 10 may be a budget-driven program or programs in which budget plan 20 may be the controlling documentation defining the program or programs. One example of such a budget-driven program or programs may be a government funded program such as a ballistic missile defense program. By way of further example and not by way of limitation, the program analyzed by system 10 may be a demand-driven program in which deployment plan 24 may be the controlling documentation defining the program. One example of such a demand-driven program may be a marketing program geared to satisfy market demand in a new sales area. By way of still further example and not by way of limitation, the program analyzed by system 10 may be a schedule-driven program in which schedule plan 22 may be the controlling documentation defining the program. One example of such a schedule-driven program may be a production program geared to roll out a new product in a marketplace.

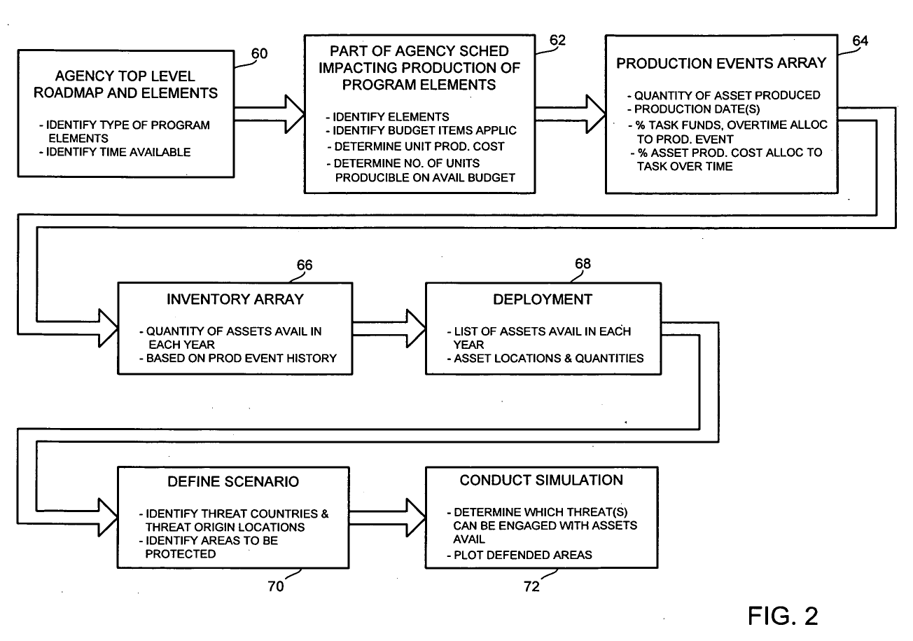

FIG. 2 is a schematic diagram illustrating an expanded expression of portions of logic illustrated in FIG. 1. In FIG. 2, logic elements presented to illustrate embodiments of the invention are cast in terms of a budget-driven program. One example of such a budget-driven program may be a government funded program such as a ballistic missile defense program. In FIG. 2, a logic element 60 may involve digitally representing aspects of a government agency top level roadmap and elements of the roadmap. Government agencies may base a program upon a broadly stated roadmap document for establishing direction and scope of the program. First logic element 60 may involve digitally representing type or types of program elements and time available for implementation of the program.

A logic element 62 may involve digitally representing portions of a government agency schedule in so far as the schedule portions impact production of program elements (e.g., ballistic missiles, or ballistic missile launcher units). Schedule portions may also impact other key events in the program or programs that may not be directly involved with production of a program element, such as, by way of example and not by way of limitation, a major design review or system test. Logic element 62 may involve digitally representing identified elements associated with the program, budget items applicable to the identified elements, unit production costs for the identified elements and number of units producible given an available budget.

A logic element 64 may involve digitally representing productivity events associated with a program. Logic element 64 may involve digitally representing quantity of elements produced, production dates for given elements of the program, percentage of task funding over a predetermined time frame allocated to a production event and percentage of asset production cost allocated to a task over a predetermined time frame.

A logic element 66 may involve digitally representing inventory levels associated with elements of a program. Logic element 66 may involve digitally representing quantity of assets available in each year of a multi-year program. Inventory representations may be based upon production event historical records.

A logic element 68 may involve digitally representing deployment of products or other elements of a program. Logic element 68 may involve digitally representing lists of asset locations as assets become available in each year of a multi-year program.

A logic element 70 may involve digitally representing scenarios in which elements of a program may be deployed. Such a scenario may include, by way of example and not by way of limitation, digitally representing an assessment of threats, countries and threat origin locations against which a ballistic missile defense system must be able to defend. Logic element 62 may involve digitally representing geographical areas to be protected by a ballistic missile defense program.

A logic element 72 may involve conducting a simulation of a program, including changes provided by a user. By way of example and not by way of limitation, a user may provide changes using a user input unit (see user input unit 40; FIG. 1). Logic element 72 may involve simulating which threats may be engaged using assets available and may plot defended areas. Logic element 72 may cooperate with logic elements 60, 62, 64, 68, 70 to facilitate a user's evaluating alternate aspects of a program such as, by way of example and not by way of limitation, budget changes, schedule changes, production level changes, production mix changes among elements of a program or other changes in a what-if sort of evaluation. Impact of a change entered at one of logic elements 60, 62, 64, 66, 68, 70 may be simulated by logic unit 72 to permit evaluation of the impact by a decision maker.

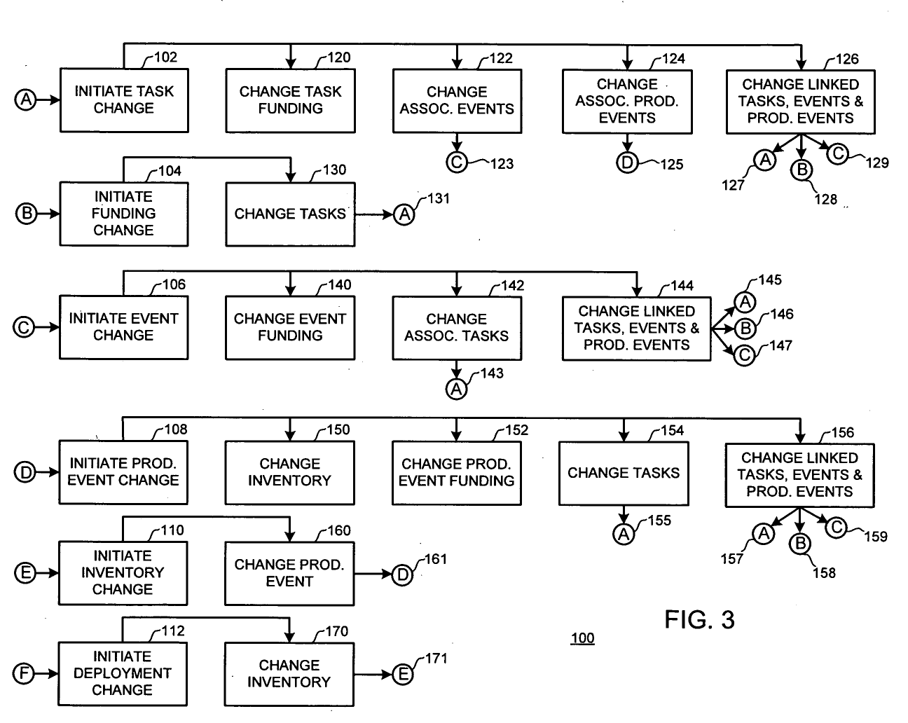

FIG. 3 is a schematic diagram illustrating logic relationships associated with operating embodiments of the present invention. In FIG. 3, logic relationships such as may be exercised, by way of example and not by way of limitation, in a computer or similar logical expression exercising device 100 may include a plurality of logic junctures A, B, C, D, E, F. Logic juncture A may provide access to a change initiating unit 102 for initiating a change of task associated with a program being analyzed. Logic juncture B may provide access to a change initiating unit 104 for initiating a change of funding associated with a program being analyzed. Logic juncture C may provide access to a change initiating unit 106 for initiating a change of an event associated with a program being analyzed. Logic juncture D may provide access to a change initiating unit 108 for initiating a change of a production event associated with a program being analyzed. Logic juncture E may provide access to a change initiating unit 110 for initiating a change of inventory associated with a program being analyzed. Logic juncture F may provide access to a change initiating unit 112 for initiating a change of deployment associated with a program being analyzed.

Employing change initiating unit 102 to initiate a change of task associated with a program being analyzed may involve a change logic unit 120 for effecting a change of funding relating to a program being analyzed and may involve a change logic unit 122. Change logic unit 122 may link to logic juncture C to cause logic initiating unit 106 to initiate a change of event associated with a program being analyzed, as indicated by a link 123. Employing change logic unit 102 to initiate a change of task associated with a program being analyzed may further involve a change logic unit 124. Change logic unit 124 may link to logic juncture D to cause logic initiating unit 108 to initiate a change of associated production event relating to a program being analyzed, as indicated by a link 125. Employing change logic unit 102 to initiate a change of task associated with a program being analyzed may still further involve a change logic unit 126. Change logic unit 126 may link to one or more of logic junctures A, B, C to cause one or more of logic initiating units 102, 104, 106 to initiate changes in linked tasks, events and production events, as indicated by links 127, 128, 129. Linked tasks, events and production events may be previously identified, such as by way of example and not by way of limitation, in relations among detailed entries of budget plan 20, schedule plan 22 and deployment plan 24 are represented by a dashed line 28 coupling budget model 12, schedule model 14 and deployment module 16 (FIG. 1).

Employing change initiating unit 104 to initiate a funding change associated with a program being analyzed may involve a change logic unit 130 for effecting a change of tasks relating to a program being analyzed. Change logic unit 130 may link to logic juncture A to cause logic initiating unit 102 to initiate a change of task associated with a program being analyzed, as indicated by a link 131.

Employing change initiating unit 106 to initiate a change of event associated with a program being analyzed may involve a change logic unit 140 for effecting a change of funding relating to a program being analyzed and may involve a change logic unit 142. Change logic unit 142 may link to logic juncture A to cause logic initiating unit 102 to initiate a change of task associated with a program being analyzed, as indicated by a link 143. Employing change logic unit 106 to initiate a change of event associated with a program being analyzed may further involve a change logic unit 144. Change logic unit 144 may link to one or more of logic junctures A, B, C to cause one or more of logic initiating units 102, 104, 106 to initiate changes in linked tasks, events and production events, as indicated by links 145, 146, 147.

Employing change initiating unit 108 to initiate a change of production event associated with a program being analyzed may involve a change logic unit 150 for effecting a change of inventory relating to a program being analyzed, may involve a change logic unit 152 for effecting a change of event funding relating to a program being analyzed and may involve a change logic unit 154. Change logic unit 154 may link to logic juncture A to cause logic initiating unit 102 to initiate a change of task associated with a program being analyzed, as indicated by a link 155. Employing change logic unit 108 to initiate a change of production event associated with a program being analyzed may further involve a change logic unit 156. Change logic unit 156 may link to one or more of logic junctures A, B, C to cause one or more of logic initiating units 102, 104, 106 to initiate changes in linked tasks, events and production events, as indicated by links 157, 158, 159.

Employing change initiating unit 110 to initiate a change of inventory associated with a program being analyzed may involve a change logic unit 160. Change logic unit 160 may link to logic juncture D to cause logic initiating unit 108 to initiate a change of associated production event relating to a program being analyzed, as indicated by a link 161.

Employing change initiating unit 112 to initiate a change of deployment associated with a program being analyzed may involve a change logic unit 170. Change logic unit 170 may link to logic juncture E to cause logic initiating unit 110 to initiate a change of inventory associated with a program being analyzed, as indicated by a link 171.

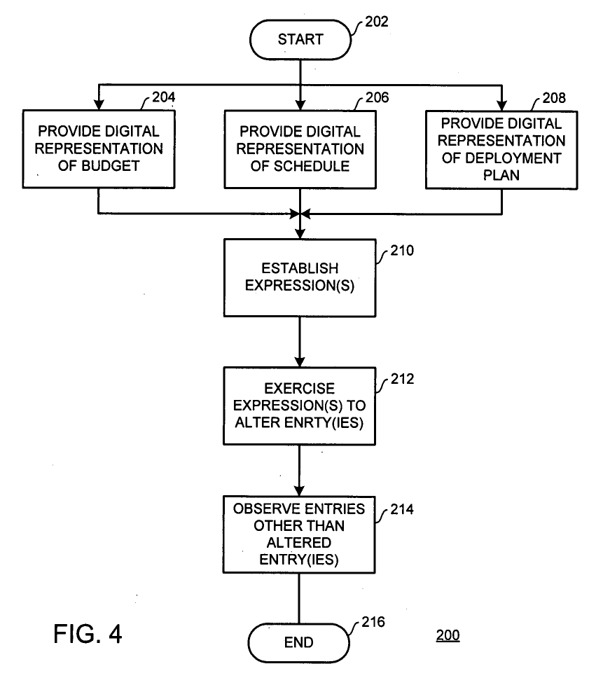

FIG. 4 is a flow chart illustrating an embodiment of the method of the invention. In FIG. 4, a method 200 for analyzing a program begins at a START locus 202. The program may have a budget, an implementation schedule and a deployment plan for effecting a planned result. Method 200 may continue by, in no particular order: (1) Providing a digital representation of the budget, as indicated by a block 204. The budget may include a plurality of first detailed entries. (2) Providing a digital representation of the schedule, as indicated by a block 206. The schedule may include a plurality of second detailed entries. Selected second detailed entries of the plurality of second detailed entries may have at least one first relation with selected first detailed entries of the plurality of first detailed entries. (3) Providing a digital representation of the deployment plan, as indicated by a block 208. The deployment plan may include a plurality of third detailed entries. Selected third detailed entries of the plurality of third detailed entries may have at least one second relation with at least one of the selected first detailed entries and the selected second detailed entries.

Method 200 may continue with establishing at least one expression embodying the at least one first relation and the at least one second relation, as indicated by a block 210. Method 200 may continue by exercising the at least one expression to effect altering at least one altered detailed entry of the selected first detailed entries, the selected second detailed entries and the selected third detailed entries, as indicated by a block 212. Method 200 may continue by observing at least one detailed entry of the selected first detailed entries, the selected second detailed entries and the selected third detailed entries other than the at least one altered detailed entry, as indicated by a block 214. Method 200 may terminate at an END locus 216.

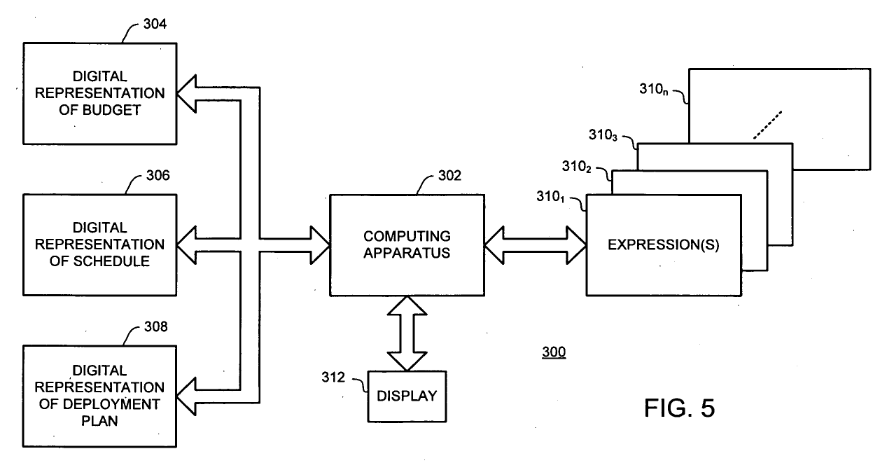

FIG. 5 is a block diagram illustrating an embodiment of the system of the invention. In FIG. 5, a system 300 for facilitating analysis of a program may include a computing apparatus 302. The program may have a budget, an implementation schedule and a deployment plan for effecting a planned result.

System 300 may also include a digital representation of the budget 304 coupled for access by computing apparatus 302. The budget may include a plurality of first detailed entries. System 300 may further include a digital representation of the schedule 306 coupled for access by computing apparatus 302. The schedule may include a plurality of second detailed entries. Selected second detailed entries of the plurality of second detailed entries may have at least one first relation with selected first detailed entries of the plurality of first detailed entries. System 300 may also include a digital representation of the deployment plan 308 coupled for access by computing apparatus 302. The deployment plan may include a plurality of third detailed entries. Selected third detailed entries of the plurality of third detailed entries may have at least one second relation with at least one of the selected first detailed entries and the selected second detailed entries.

System 300 may still further include at least one expression configured for exercising by the computing apparatus 310₁, 310₂, 310₃, 310ₙ. The indicator “n” is employed to signify that there can be any number of expressions included in system 300. The inclusion of four expressions 310₁, 310₂, 310₃, 310ₙ in FIG. 5 is illustrative only and does not constitute any limitation regarding the number of expressions that may be included in embodiments of the system of the present invention. The at least one expression may embody the at least one first relation and the at least one second relation. The exercising of the at least one expression may effect altering at least one altered detailed entry of the selected first detailed entries, the selected second detailed entries and the selected third detailed entries. Observing at least one detailed entry of the selected first detailed entries, the selected second detailed entries and the selected third detailed entries other than the at least one altered detailed entry may effect the facilitating.

System 300 may also include a display unit 312 coupled with computing apparatus 310 to aid a user in evaluating program analysis results.

Embodiments of the method and system of the invention may permit program decision makers to answer what-if questions, conduct studies and explore alternatives in developing a program. The program may be constrained or driven principally by a budget as, for example, in the case of a government funded program like the Ballistic Missile Defense Program. The program may be constrained or driven principally by a schedule as, for example, in the case of a commercial launch of a new product line. The program may be constrained or driven principally by a deployment plan as, for example, in the case of a company planning to enter a new market or new region. Embodiments of the present invention may permit altering parameters associated with one aspect of a program such as, by way of example and not by way of limitation, budget aspects, schedule aspects or deployment aspects, to permit evaluation of impacts on unchanged parameters.

In an exemplary case of a Ballistic Missile Defense program, a decision maker may change budget allocations among program aspects to permit examining impacts relating to program schedule and program element availability. Impacts may be revealed extending even to the deployment plan of the program to affect defense effectiveness against hostile ballistic missiles.

Embodiments of the invention may capture the interdependency of a multi-year, multi-program budget, schedule, and deployment or architecture elements in an integrated and interactive manner. Embodiments of the invention may permit decision makers to change one parameter and observe potential resulting effects on the other two parameters. Embodiments of the invention may permit a decision maker to evaluate trade-offs to rebalance budget and program elements.

Embodiments of the invention may permit a user or decision maker to gain an in-depth understanding of the changes in program performance after deployment as a result of actions or changes in budgeted funding or production schedules.

Embodiments of the invention may permit analysis of an integrated problem involving budget, schedule, and deployment performance for a product in the future by a user having limited experience with the product.

Embodiments of the invention may permit analysis of an evolving program over several cycles of a budget, production, deployment or other aspect of the program, rather than limiting analysis to a single cycle.

It is to be understood that, while the detailed drawings and specific examples given describe embodiments of the invention, they are for the purpose of illustration only, that the apparatus and method of the invention are not limited to the precise details and conditions disclosed and that various changes may be made therein without departing from the spirit of embodiments of the invention which is defined by the following claims:

I claim:

1. A method for analyzing at least one program; said at least one program having a budget, an implementation schedule and a deployment plan for effecting a planned result; the method comprising the steps of:
(a) in no particular order:
(1) providing a digital representation of said budget;
(2) providing a digital representation of said schedule; and
(3) providing a digital representation of said deployment plan;
(b) establishing at least one expression embodying at least one relation involving at least two of said budget, said schedule and said deployment plan;
(c) exercising said at least one expression to effect altering at least one first factor relating to at least one of said budget, said schedule and said deployment plan; and
(d) observing at least one second factor relating to at least one of said budget, said schedule and said deployment plan.

2. A method for analyzing at least one program as recited in claim 1 wherein said digital representation of said budget includes digital representation of funding levels relating to a plurality of tasks; completion of selected tasks of said plurality of tasks relating to effecting respective events of a plurality of events.

3. A method for analyzing at least one program as recited in claim 1 wherein said digital representation of said schedule includes digital representation of a relation of completion of said plurality of events with a plurality of scheduled times; completion of selected events of said plurality of events yielding an inventory level of respective elements of a plurality of elements.

4. A method for analyzing at least one program as recited in claim 1 wherein said digital representation of said deployment plan includes digital representation of a relation of location with quantities and types of said respective elements.

5. A method for analyzing at least one program as recited in claim 2 wherein said digital representation of said schedule includes digital representation of a relation of completion of said plurality of events with a plurality of scheduled times; completion of selected events of said plurality of events yielding an inventory level of respective elements of a plurality of elements.

6. A method for analyzing at least one program as recited in claim 5 wherein said digital representation of said deployment plan includes digital representation of a relation of location with quantities and types of said respective elements.

7. A method for analyzing at least one program as recited in claim 6 wherein said program is a ballistic missile defense program, wherein said plurality of elements is a plurality of elements of a ballistic missile defense system, and wherein said deployment plan is a strategic missile defense plan for deploying said elements.

8. A method for analyzing at least one program; said at least one program having a budget, an implementation schedule and a deployment plan for effecting a planned result; the method comprising the steps of:
(a) in no particular order:
(1) providing a digital representation of said budget; said budget including a plurality of first entries;
(2) providing a digital representation of said schedule; said schedule including a plurality of second entries; and
(3) providing a digital representation of said deployment plan; said deployment plan including a plurality of third entries;
(b) establishing at least one expression embodying at least one relation among said first entries, said second entries and said third entries;
(c) exercising said at least one expression to effect altering at least entry of said first entries, said second entries and said third entries; and
(d) observing at least one entry of said first entries, said second entries and said third entries other than said at least one altered entry.

9. A method for analyzing at least one program as recited in claim 8 wherein said at least one program is a ballistic missile defense program, wherein said plurality of elements is a plurality of elements of a ballistic missile defense system, and wherein said deployment plan is a strategic missile defense plan for deploying said elements.

10. A method for analyzing at least one program as recited in claim 8 wherein said at least one program is a budget-driven at least one program; said budget being the controlling documentation defining said at least one program.

11. A method for analyzing at least one program as recited in claim 8 wherein said at least one program is a demand-driven at least one program; said selected third detailed entries including factors relating to demand for said respective elements.

12. A system for facilitating analysis of at least one program; said at least one program having a budget, an implementation schedule and a deployment plan for effecting a planned result; the system comprising:
(a) a computing apparatus;
(b) a digital representation of said budget coupled for access by said computing apparatus; said budget including a plurality of first detailed entries;
(c) a digital representation of said schedule coupled for access by said computing apparatus; said schedule including a plurality of second detailed entries; selected second detailed entries of said plurality of second detailed entries having at least one first relation with selected first detailed entries of said plurality of first detailed entries;
(d) a digital representation of said deployment plan coupled for access by said computing apparatus; said deployment plan including a plurality of third detailed entries; selected third detailed entries of said plurality of third detailed entries having at least one second relation with at least one of said selected first detailed entries and said selected second detailed entries;
(e) at least one expression configured for exercising by said computing apparatus; said at least one expression embodying said at least one first relation and said at least one second relation; said exercising said at least one expression effecting altering at least one altered detailed entry of said selected first detailed entries, said selected second detailed entries and said selected third detailed entries; observing at least one detailed entry of said selected first detailed entries, said selected second detailed entries and said selected third detailed entries other than said at least one altered detailed entry effecting said facilitating.

13. A system for facilitating analysis of at least one program as recited in claim 12 wherein said plurality of first detailed entries includes funding levels relating to a plurality of tasks; completion of selected tasks of said plurality of tasks relating to effecting respective events of a plurality of events.

14. A system for facilitating analysis of at least one program as recited in claim 12 wherein said plurality of second detailed entries includes relation of completion of said plurality of events at a plurality of scheduled times; completion of selected events of said plurality of events yielding an inventory level of respective elements of a plurality of elements.

15. A system for facilitating analysis of at least one program as recited in claim 12 wherein said plurality of third detailed entries includes relation of location with quantities and types of said respective elements.

16. A system for facilitating analysis of at least one program as recited in claim 13 wherein said plurality of second detailed entries includes relation of completion of said plurality of events at a plurality of scheduled times; completion of selected events of said plurality of events yielding an inventory level of respective elements of a plurality of elements.

17. A system for facilitating analysis of at least one program as recited in claim 16 wherein said plurality of third detailed entries includes relation of location with quantities and types of said respective elements.

18. A system for facilitating analysis of at least one program as recited in claim 17 wherein said at least one program is a ballistic missile defense at least one program, wherein said plurality of elements is a plurality of elements of a ballistic missile defense system, and wherein said deployment plan is a strategic missile defense plan for deploying said elements.

19. A system for facilitating analysis of at least one program as recited in claim 12 wherein said at least one program is a budget-driven at least one program; said budget being the controlling documentation defining said at least one program.

20. A system for facilitating analysis of at least one program as recited in claim 8 wherein said at least one program is a demand-driven at least one program; said selected third detailed entries including factors relating to demand for said respective elements.
